(19) United States
(12) Patent Application Publication
(10) Pub. No.: US 2009/0072651 A1
(43) Pub. Date: Mar. 19, 2009

(54) SLOTLESS WINDING FOR ROTATING ELECTRIC MACHINE AND MANUFACTURING METHOD THEREOF

(75) Inventors: Guo-Jhih YAN, Kaohsiung (TW); Guang-Miao HUANG, Kaohsiung (TW); Hsin-Te WANG, Kaohsiung (TW); Liang-Yi HSU, Kaohsiung (TW); Mi-Ching TSAI, Kaohsiung (TW)

Correspondence Address: VOLENTINE & WHITT PLLC, ONE FREEDOM SQUARE, 11951 FREEDOM DRIVE SUITE 1260, RESTON, VA, 20190, US

(73) Assignee: METAL INDUSTRIES RESEARCH & DEVELOPMENT CENTRE, Kaohsiung (TW)

(21) Appl. No.: 11/959,618

(22) Filed: Dec. 19, 2007

(30) Foreign Application Priority Data
Sep. 13, 2007 (TW) 096134263

(51) Int. Cl. H01F 5/02; H02K 3/26; H01F 41/04; H02K 15/04

(52) U.S. Cl. 310/179; 29/596; 336/200; 336/185; 29/850

(57) ABSTRACT

The present invention relates to a slotless winding for a rotating electric machine and a manufacturing method thereof. The slotless winding includes at least one flexible printed circuit board having at least one circuit, and one piece of flexible printed circuit board(s) is curved or a plurality of pieces of flexible printed circuit board(s) is mutually combined to form a barrel shape, thereby simplifying the procedure of manufacturing the slotless winding, improving production speed and reliability, and enabling diversified designing schemes to meet the demands of the rotating electric machine. In addition, it is not necessary for the coil winding to be cured for assembling, and assembling yield is thus enhanced.

### BACKGROUND OF THE INVENTION

1. Field of the Invention

The present invention relates to a slotless winding for a rotating electric machine and a manufacturing method thereof. More particularly, the present invention relates to a slotless winding for a rotating electric machine and formed on a flexible printed circuit board and a manufacturing method thereof.

2. Description of the Related Art

FIGS. 1a-1d show schematic views of four kinds of conventional motors. In the four conventional motors, the same elements are labeled with the same reference numbers. In FIG. 1a, a first kind of conventional motor 1A includes a housing 11, a winding 12, a magnet 13, a shaft 14, and a gap 15. The winding 12 is fixed on the housing 11, the magnet 13 is fixed on the shaft 14, and the gap 15 exists between the winding 12 and the magnet 13. In electronic machinery, the winding and the components connected thereto are referred to as a primary, and the magnet and the components connected thereto are referred to as a secondary. After energization, the magnetic force between the magnet 13 and the winding 12 can drive the primary and the secondary to rotate respective to each other.

In FIG. 1b, the elements of a second kind of conventional motor 1B are substantially the same as elements of the first kind of conventional motor 1A, except that the arrangement thereof is different. The second kind of conventional motor 1B includes a housing 11, a winding 12, a magnet 13, a shaft 14, a gap 15, and a back iron 16. The magnet 13 is fixed on the housing 11, the winding 12 and the back iron 16 are fixed on the shaft 14, and the gap 15 exists between the winding 12 and the magnet 13. After energization, the magnetic force between the magnet 13 and the winding 12 can drive the primary and the secondary to rotate relative to each other.

FIG. 1c, the elements of a third kind of conventional motor 1C are substantially the same as elements of the first kind of conventional motor 1A, except that the arrangement thereof is different. The third kind of conventional motor 1C includes a housing 11, a winding 12, a first magnet 131, a second magnet 132, a shaft 14, a first gap 151, and a second gap 152. The first magnet 131 is fixed on the housing 11, the second magnet 132 is fixed on the shaft 14, the first gap 151 exists between the winding 12 and the first magnet 131, and the second gap 152 exists between the winding 12 and the second magnet 132.

In FIG. 1d, the elements of a fourth kind of conventional motor 1D are substantially the same as elements of the first kind of conventional motor 1A, except that the arrangement thereof is different. The fourth kind of conventional motor 1D includes a housing 11, a first winding 121, a second winding 122, a magnet 12, a shaft 14, a first gap 151, a second gap 152, and a back iron 16. The first winding 121 is fixed on the housing 11, the second winding 122 and the back iron 16 are fixed on the shaft 14, the first gap 151 exists between the magnet 13 and the first winding 121, and the second gap 152 exists between the magnet 13 and the second winding 122.

In the four kinds of conventional motors 1A, 1B, 1C, and 1D, the windings (including the winding 12, the first winding 121, and the second winding 122) are coil windings, as shown in FIG. 2. Reference to the form of the coil winding can be seen in U.S. Pat. No. 6,507,991, U.S. Pat. No. 6,791,224, U.S. Pat. No. 5,998,905, U.S. Pat. No. 5,715,590, U.S. Pat. No. 5,606,791, U.S. Pat. No. 5,197,180 etc. The method of manufacturing the coil winding is as follows. First, a winding machine is used to wind the coil, and a connection wire is reserved and fixed on a mold holder to form an initial cylindrical coil. Then, the initial cylindrical coil is flattened and curled to an annular shape, and then cured and shaped by using resin or self-adhering enamel wire. Finally, the coil is placed into the motor.

Another manufacturing method is that a purpose made winding machine is directly used to fabricate the coil with the slotless winding design on special mold and jig. The processes of the above two methods are quite complex and require the matching of special jig and mold holder, and if the copper wire used for winding is slim, it is necessary for the winding machine to have corresponding tension controlling device to prevent the wires from breaking. After the winding is finished, it is still necessary to perform plastic compression, shaping, and curing procedures, so it is disadvantageous for mass production assembly.

Therefore, it is necessary to provide an innovative and progressive slotless winding for a rotating electric machine and a manufacturing method thereof, so as to solve the above problems.

### SUMMARY OF THE INVENTION

The present invention is mainly directed to a slotless winding for a rotating electric machine, which includes at least one flexible printed circuit board having at least one circuit. One piece of flexible printed circuit board(s) is curved or wound, or a plurality of pieces of flexible printed circuit board(s) are mutually combined to form a barrel shape.

The present invention is further directed to a method of manufacturing a slotless winding for a rotating electric machine, which includes the following steps: (a) providing at least one flexible printed circuit board; (b) forming at least one circuit on a surface of or inside each flexible printed circuit board; and (c) making the flexible printed circuit board(s) form a barrel shape.

The advantage of the present invention is that the procedure of manufacturing the slotless winding is simplified, and production speed and reliability are enhanced. Further, the winding can be designed in various ways to meet the demand of motor or generator, so as to increase the applicability of coil copper wire and to greatly improve the performance. In addition, the coil is manufactured through a semiconductor process, and thus the industrial value and technical threshold of the motor are increased. Finally, it is not necessary for the coil to be cured for assembling, thus enhancing the assembling yield.

### BRIEF DESCRIPTION OF THE DRAWINGS

FIG. 1a is a schematic view of a first kind of conventional motor;

FIG. 1b is a schematic view of a second kind of conventional motor;

FIG. 1c is a schematic view of a third kind of conventional motor;

FIG. 1d is a schematic view of a fourth kind of conventional motor;

FIG. 2 is a schematic view of a conventional coil winding;

FIG. 3a is a schematic top view of a flexible printed circuit board according to a first embodiment of the present invention, in which only a first circuit is shown;

FIG. 3b is a schematic top view of the flexible printed circuit board according to a first embodiment of the present invention, in which only a second circuit is shown;

FIG. 4 is a schematic top view of the flexible printed circuit board according to a second embodiment of the present invention;

FIG. 5a is a schematic top view of the flexible printed circuit board according to a third embodiment of the present invention, in which only a first circuit is shown;

FIG. 5b is a schematic top view of the flexible printed circuit board according to a third embodiment of the present invention, in which only a second circuit is shown;

FIG. 6 is a schematic top view of the flexible printed circuit board according to a fourth embodiment of the present invention;

FIG. 7 is a schematic top view of the flexible printed circuit board according to a fifth embodiment of the present invention;

FIG. 8 is a schematic top view of the flexible printed circuit board according to a sixth embodiment of the present invention;

FIG. 9 is a schematic view of a first type slotless winding of the present invention for the first kind of conventional motor;

FIG. 10 is a schematic view of a second type slotless winding of the present invention for the first kind of conventional motor;

FIG. 11 is a schematic view of a third type slotless winding of the present invention for the first kind of conventional motor; and

FIG. 12 is a flow chart of the method of manufacturing the slotless winding for the rotating electric machine of the present invention.

### DETAILED DESCRIPTION OF THE INVENTION

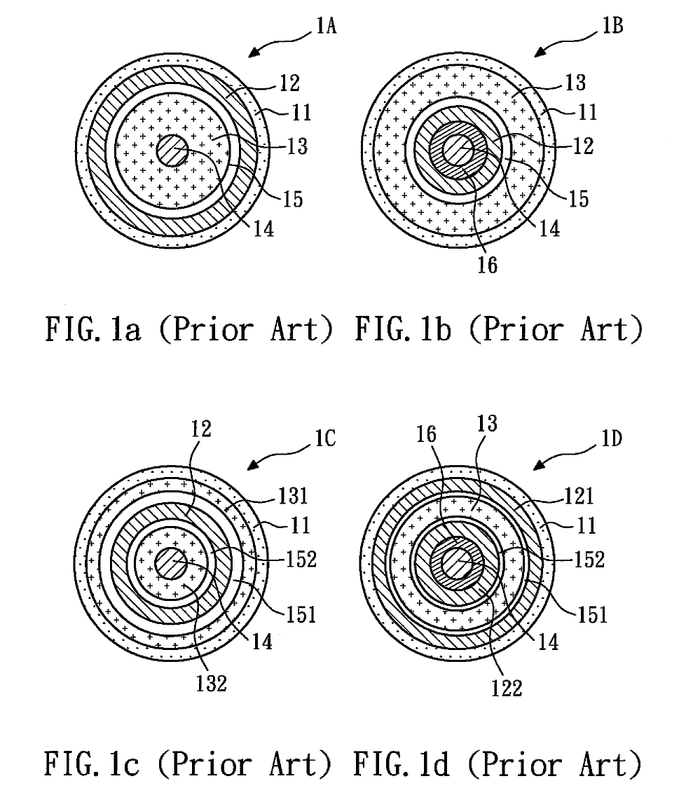

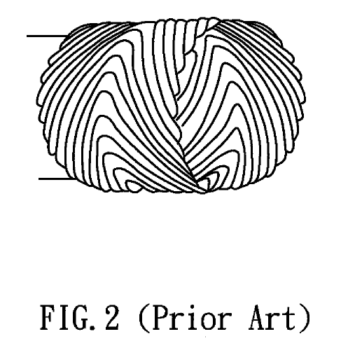

The slotless winding of the present invention can be for a rotating electric machine including but not limited to motor, generator, etc. The slotless winding of the present invention includes at least one flexible printed circuit board, the flexible printed circuit board has at least one circuit, and one piece of flexible printed circuit board(s) is curved and wound or a plurality of pieces of flexible printed circuit board(s) are mutually combined to form a barrel shape. In application, the present invention uses the slotless winding with the barrel shape formed by the flexible printed circuit board(s) to replace the conventional coil windings (including the winding 12 (FIGS. 1a, 1b, and 1c), the first winding 121, and the second winding 122 (FIG. 1d)).

In the present invention, the forming method of the circuit is selected from electrocasting, imprinting, screen printing, photolithography, ink-jet printing, and other semiconductor processes, and is preferably electrocasing. The circuit can be formed on two surfaces of or inside the flexible printed circuit board. Preferably, the circuit comprises a plurality of parallel wires. In an embodiment, in order to increase the layout density, the circuit has a first circuit and a second circuit, the first circuit and the second circuit are respectively located on different layers of the flexible printed circuit, that is, the first circuit and the second circuit can be located on two surfaces of the flexible printed circuit, or can be located on different layers in the flexible printed circuit board. In this case, the flexible printed circuit board must have a plurality of vias for connecting the first circuit and the second circuit.

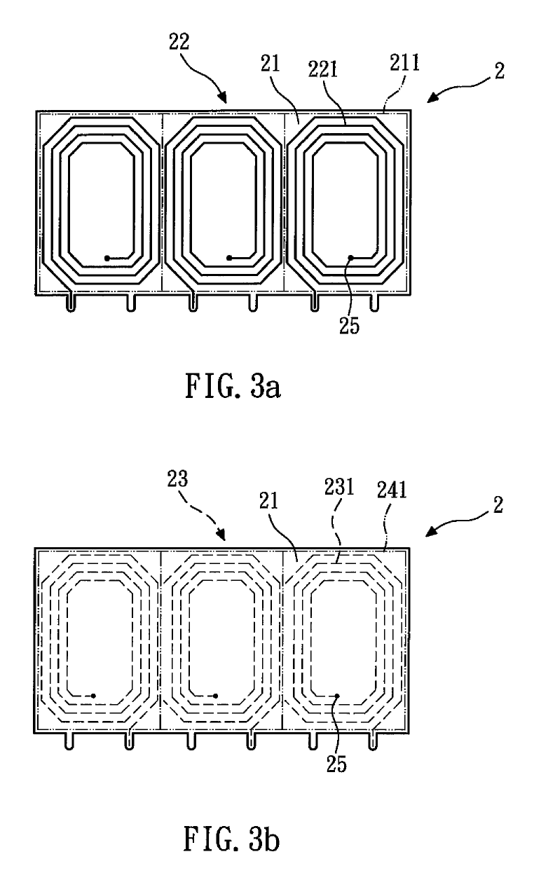

FIGS. 3a and 3b show schematic top views of the flexible printed circuit board according to a first embodiment of the present invention. FIG. 3a only shows the first circuit, and FIG. 3b only shows the second circuit. The flexible printed circuit board 2 has a first surface 21, a second surface (not shown), and a circuit. The first surface 21 has three first winding regions 211, the second surface has three second winding regions 241, and the first winding regions 211 correspond to the second winding regions 241. In other application, the number of the first winding region 211 and the second winding region 241 is not limited to three.

The circuit has a first circuit 22 and a second circuit 23, the first circuit 22 is located on the first surface 21, and the second circuit 23 is located on the second surface and is shown by dashed circuit. The first circuit 22 includes three first winding coils 221, and each first winding coil 221 is located in each first winding region 211. The first winding coil 221 comprises a plurality of mutually parallel coils wound by a wire, and in this embodiment, the first winding coil 221 is octagonal. However, in other application, the first winding coil 221 can also be triangular, rhombic, hexagonal, polygonal, oval, round, or composed of a plurality of circular arcs.

The second circuit 23 includes three second winding coils 231, and each second winding coil 231 is located in each second winding region 241. The second winding coil 231 comprises a plurality of mutually parallel coils wound by a wire, and in this embodiment, the second winding coil 231 is octagonal. However, in other application, the first winding coil 231 can also be triangular, rhombic, hexagonal, polygonal, oval, round, or composed of a plurality of circular arcs. In this embodiment, the pattern of the first circuit 22 is the same as the pattern of the second circuit 23, that is, the pattern of the first winding coil 221 is the same as the pattern of the second winding coil 231, and they are mirror images of each other. In addition, the flexible printed circuit board 2 further has a plurality of vias 25 for connecting the first circuit 22 and the second circuit 23.

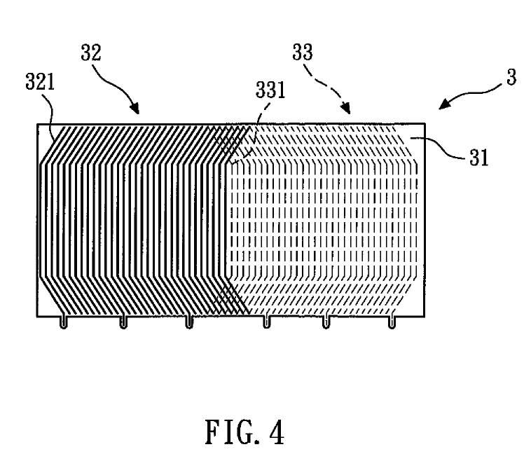

FIG. 4 shows a schematic top view of the flexible printed circuit board according to a second embodiment of the present invention. The flexible printed circuit board 3 has a first surface 31, a second surface (not shown), and a circuit. The circuit has a first circuit 32 and a second circuit 33, the first circuit 32 is located on the first surface 31, and the second circuit 33 is located on the second surface and is shown by dashed circuit. The pattern of the first circuit 32 comprises a plurality of mutually parallel first wires 321, and the first wires 321 are quasi-U-shaped with openings in the horizontal direction (to the right in the drawing). The pattern of the second circuit 33 comprises a plurality of mutually parallel second wires 331, and the second wires 331 are quasi-U-shaped with openings in the horizontal direction (to the left in the drawing).

In this embodiment, the pattern of the first circuit 32 is the same as the pattern of the second circuit 33, that is, the pattern of the first wires 321 is the same as the pattern of the second wires 331, and they are mirror images of each other. In addition, the flexible printed circuit board 3 further has a plurality of vias (not shown) for connecting the first circuit 32 and the second circuit 33, so as to form a plurality of mutually parallel octagonal coils.

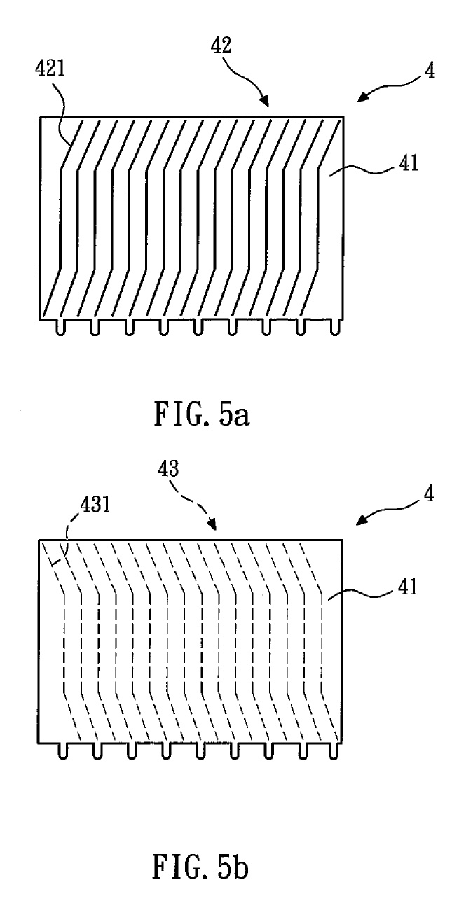

FIGS. 5a and 5b show schematic top views of the flexible printed circuit board according to a third embodiment of the present invention. FIG. 5a only shows a first circuit, and FIG. 5b only shows a second circuit. The flexible printed circuit board 4 has a first surface 41, a second surface (not shown), and a circuit. The circuit has a first circuit 42 and a second circuit 43, the first circuit 42 is located on the first surface 41, and the second circuit 43 is located on the second surface and is shown by dashed circuit. The pattern of the first circuit 42 comprises a plurality of wave-shaped first wires 421, and the first wires 421 are mutually parallel. The pattern of the second circuit 43 comprises a plurality of wave-shaped second wires 431, and the second wires 431 are mutually parallel.

In this embodiment, the pattern of the first circuit 42 is the same as the pattern of the second circuit 43, that is, the pattern of the first wires 421 is the same as the pattern of the second wires 431, and they are mirror images of each other. In addition, the flexible printed circuit board 4 further has a plurality of vias (not shown) for connecting the first circuit 42 and the second circuit 43.

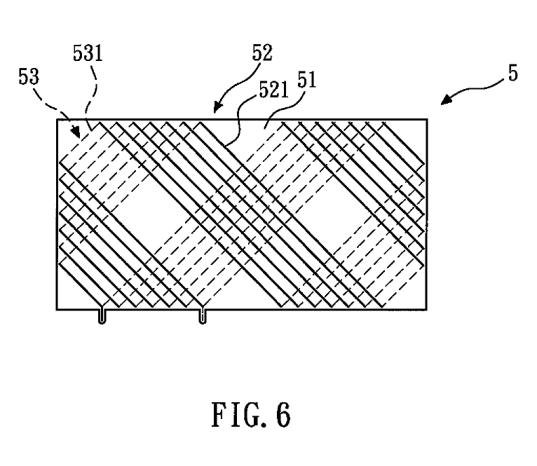

FIG. 6 shows a schematic top view of the flexible printed circuit board according to a fourth embodiment of the present invention. The flexible printed circuit board 5 has a first surface 51, a second surface (not shown), and a circuit. The circuit has a first circuit 52 and a second circuit 53. The first circuit 52 is located on the first surface 51, and is shown by solid circuit. The second circuit 53 is located on the second surface, and is shown by dashed circuit. The pattern of the first circuit 52 comprises a plurality of obliquely parallel first wires 521, and the pattern of the second circuit 53 comprises a plurality of obliquely parallel second wires 531.

In this embodiment, the pattern of the first circuit 52 is the same as the pattern of the second circuit 53, that is, the pattern of the first wires 521 is the same as the pattern of the second wires 531, and they are mirror images of each other. In addition, the flexible printed circuit board 5 further has a plurality of vias (not shown) for connecting the first circuit 52 and the second circuit 53.

For convenience of illustration, the circuit of each embodiment includes a first circuit and a second circuit disposed on different layers of the flexible printed circuit board. In practical application, the circuit can further include a third circuit, a fourth circuit, etc. disposed on different layers of the flexible printed circuit board, and the number of circuits can be increased as desired.

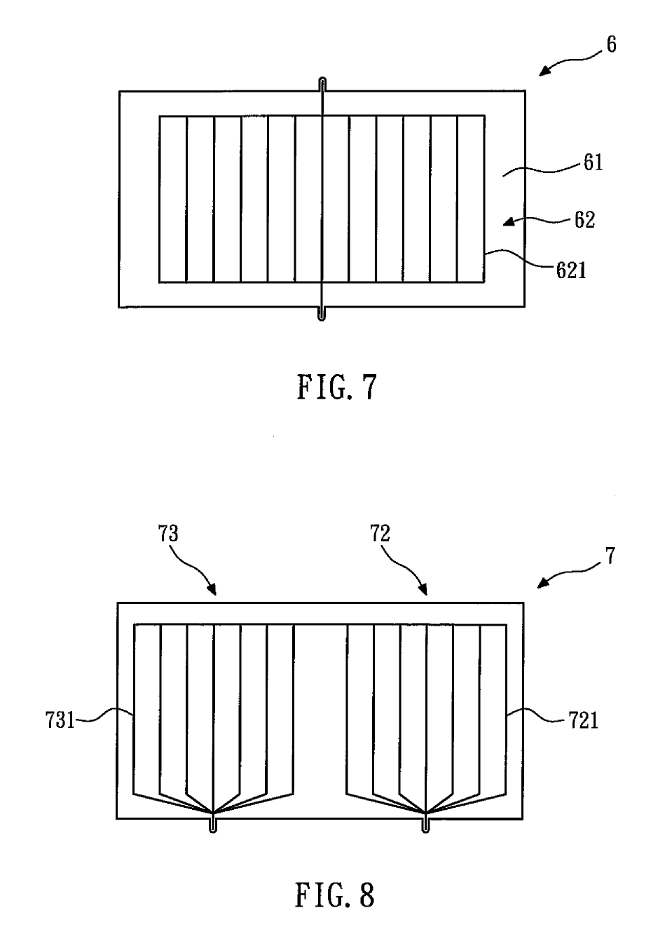

FIG. 7 shows a schematic top view of the flexible printed circuit board according to a fifth embodiment of the present invention. A surface 61 of the flexible printed circuit board 6 has a circuit including a wire group 62. The pattern of the wire group 62 comprises a plurality of mutually parallel wires 621, and the wires 621 are connected in parallel.

As used herein, the term “wire group” refers to a set of wires in the circuit of the same layer. Therefore, one winding coil of FIGS. 3a and 3b is equivalent to one wire group.

FIG. 8 shows a schematic top view of the flexible printed circuit board according to a sixth embodiment of the present invention. The flexible printed circuit board 7 has a circuit, and the circuit includes a plurality of wire groups. The circuit of the embodiment as shown in FIG. 8 includes a first wire group 72 and a second wire group 73. The pattern of the first wire group 72 comprises a plurality of parallel first wires 721. The pattern of the second wire group 73 comprises a plurality of parallel second wires 731. In this embodiment, the pattern of the first wire group 72 is the same as the pattern of the second wire group 73, that is, the pattern of the first wires 721 is the same as the pattern of the second wires 731, and they are mirror images of each other. The first wires 721 of the first wire group 72 are mutually connected in parallel, and similarly, the second wires 731 of the second wire group 73 are also mutually connected in parallel. The first wire group 72 and the second wire group 73 are serially connected by at least one wire. The first wire group 72 and the second wire group 73 can be disposed on the same layer of the flexible printed circuit board 7 or disposed on different layers and are connected by vias.

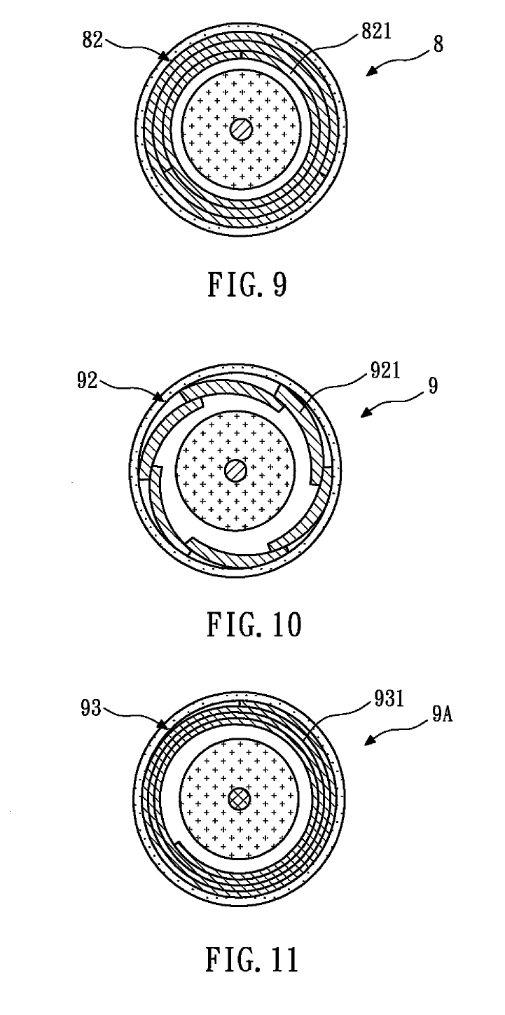

FIG. 9 shows a schematic view of a first type of slotless winding of the present invention for the first kind of conventional motor. A motor 8 as shown in the drawing is substantially the same as the first kind of conventional motor 1A as shown in FIG. 1a, only except that in the motor 8, a slotless winding 82 is used to replace the coil winding 12 in the first kind of conventional motor 1A. The slotless winding 82 is the first type of slotless winding of the present invention, has a three-layer structure, and is formed by joining three flexible printed circuit boards 821 end to end to form a barrel shape and then stacking the three flexible printed circuit boards 821. In other applications, the first type of slotless winding can be a single flexible printed circuit board 821 joined end to end to form a barrel shape. The flexible printed circuit board 821 is the flexible printed circuit board of the present invention.

FIG. 10 shows a schematic view of a second type of slotless winding of the present invention for the first kind of conventional motor. A motor 9 as shown in the drawing is substantially the same as the first kind of conventional motor 1A as shown in FIG. 1a, only except that in the motor 9, a slotless winding 92 is used to replace the coil winding 12 in the first kind of conventional motor 1A. The slotless winding 92 is the second type of slotless winding of the present invention, and is formed by combining one end of each flexible printed circuit board 921 with one end of an adjacent flexible printed circuit board so as to form a barrel shape. The flexible printed circuit board 921 is the flexible printed circuit board of the present invention.

FIG. 11 shows a schematic view of a third type of slotless winding of the present invention for the first kind of conventional motor. A motor 9A as shown in the drawing is approximately the same as the first kind of conventional motor 1A as shown in FIG. 1a, only except that in the motor 9A, a slotless winding 93 is used to replace the coil winding 12 in the first kind of conventional motor 1A. The slotless winding 93 is the third type of slotless winding of the present invention, and is formed by winding one piece of flexible printed circuit board 931 for a plurality of turns to form a multi-layer structure. The flexible printed circuit board 931 is the flexible printed circuit board of the present invention.

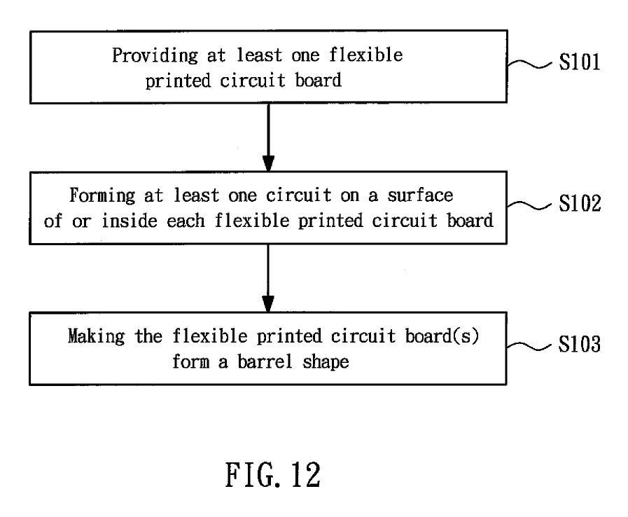

FIG. 12 shows a flow chart of a method of manufacturing a slotless winding for a rotating electric machine of the present invention. In step S101, at least one flexible printed circuit board is provided. The flexible printed circuit board has a first surface and a second surface, and at least one winding region is pre-divided from the flexible printed board. In step S102, at least one circuit is formed on a surface of or inside each flexible printed circuit board. The forming method of the circuit is selected from electrocasting, imprinting, screen printing, photolithography, ink-jet printing, and other semiconductor processes, and is preferably electrocasing. In an embodiment, the circuit includes at least one winding coil, each winding coil being located in each winding region and comprises a plurality of mutually parallel coils wound by a wire. The winding coil can be triangular, rhombic, hexagonal, octagonal, polygonal, oval, round, or composed of a plurality of circular arcs. In the embodiment of the present invention, the circuit comprises a plurality of parallel wires, and the wires are wave-shaped or oblique, and are parallel to one another.

In the embodiment of the present invention, the circuit has a first circuit and a second circuit, the first circuit and the second circuit are respectively located on different layers of the flexible printed circuit board. Preferably, the first circuit is located on a first surface, and the second circuit is located on a second surface. The flexible printed circuit board further has a plurality of vias for connecting the first circuit and the second circuit. Preferably, the pattern of the first circuit is the same as the pattern of the second circuit, and the pattern of the first circuit and the pattern of the second circuit are mirror images of each other.

The patterns of the first circuit and the second circuit include but are not limited to the three following types.

In a first type, the first surface includes at least one first winding region, the second surface includes at least one second winding region, the circuit includes at least one first winding coil and at least one second winding coil, each first winding coil is located in each first winding region, each second winding coil is located in each second winding region, each first winding coil comprises a plurality of mutually parallel coils wound by a wire, and each second winding coil comprises a plurality of mutually parallel coils wound by a wire, as shown in FIGS. 3a and 3b.

In a second type, the pattern of the first circuit comprises a plurality of wave-shaped or oblique first wires, and the first wires are mutually parallel; the pattern of the second circuit comprises a plurality of wave-shaped or oblique second wires, and the second wires are mutually parallel, as shown in FIGS. 5a, 5b, and 6.

In a third type, the pattern of the first circuit comprises a plurality of mutually parallel first wires, and the first wires are quasi-U-shaped with openings in the horizontal direction; the pattern of the second circuit comprises a plurality of mutually parallel second wires, and the second wires are quasi-U-shaped with openings in the horizontal direction, as shown in FIG. 4.

In step S103, the flexible printed circuit board(s) form(s) a barrel shape. The method of forming the barrel shape includes but is not limited to the three following types.

In a first method, each flexible printed circuit board is joined end to end to form a barrel shape, and a plurality of flexible printed circuit board are stacked together to form a multi-layer structure, as shown in FIG. 9. In a second method, one end of each flexible printed circuit board is combined with one end of a adjacent flexible printed circuit board, so as to form a barrel shape, as shown in FIG. 10. In a third method, one piece of flexible printed circuit board is wound for a plurality of turns, so as to form a multi-layer structure, as shown in FIG. 11.

The present invention has the following advantages. 1. The flexible printed circuit board is used to fabricate the winding without iron core, winding types corresponding to motor or generator rotor magnet can be directly drawn on the printed circuit board, and winding is wound or curled to be round or of various shapes to serve as motor or generator stator coil, so as to simplify the process of fabricating the slotless winding. 2. The conductor is patterned on the flexible printed circuit board directly, which is not limited by the conventional method of fabricating the winding, so as to generate various winding types suitable for different motor or generator designs. 3. Wires of different sizes can be directly fabricated, so the thickness of the winding can be controlled to reduce loss of copper, and the windings are mutually stacked in an offset manner with multi-layer layout technique, so as to suit various designs, and to effectively downsize the motor or the generator. 4. After being wound and shaped, the winding fabricated by using flexible printed circuit board has certain strength, so it is not necessary to add the resin for curing. As a result, the procedure is simplified and the subsequent assembling is made convenient, which is helpful to the assembling automatization process after the downsizing of the motor or the generator.

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope defined in the appended claims.

What is claimed is:

1. A slotless winding for a rotating electric machine, comprising at least one flexible printed circuit board having at least one circuit, and one piece of flexible printed circuit board(s) is curved and wound or a plurality of pieces of flexible printed circuit board(s) are mutually combined to form a barrel shape.

2. The slotless winding as claimed in claim 1, wherein the circuit comprises a plurality of wires.

3. The slotless winding as claimed in claim 2, wherein the wires are mutually connected in parallel.

4. The slotless winding as claimed in claim 1, wherein the flexible printed circuit board comprises at least one winding region, the circuit comprises at least one winding coil, each winding coil is located in each winding region, and each winding coil comprises a plurality of mutually parallel coils wound by a wire.

5. The slotless winding as claimed in claim 1, wherein the slotless winding comprises a plurality of flexible printed circuit boards, each flexible printed circuit board is joined end to end to form a barrel shape, and the flexible printed circuit boards of the barrel shape are mutually stacked to form a multi-layer barrel-shaped structure.

6. The slotless winding as claimed in claim 1, wherein the slotless winding comprises a flexible printed circuit board, the flexible printed circuit board being joined end to end to form a barrel-shaped structure.

7. The slotless winding as claimed in claim 1, wherein the slotless winding comprises a plurality of flexible printed circuit board, and one end of each flexible printed circuit board is combined with one end of a adjacent flexible printed circuit board so as to form a barrel shape.

8. The slotless winding as claimed in claim 1, wherein the slotless winding comprises a flexible printed circuit board, and the flexible printed circuit board is wound for a plurality of turns so as to form a multi-layer barrel-shaped structure.

9. The slotless winding as claimed in claim 1, wherein the circuit has a plurality of wire groups, and the wire groups are connected by at least one wire.

10. The slotless winding as claimed in claim 9, wherein the wire groups are disposed on different layers of the flexible printed circuit board and connected by vias.

11. The slotless winding as claimed in claim 9, wherein each wire group comprises a plurality of parallel wires, and the parallel wires are mutually connected in parallel.

12. The slotless winding as claimed in claim 1, wherein the circuit has a first circuit and a second circuit, and the first circuit and the second circuit are respectively located on different layers of the flexible printed circuit board.

13. The slotless winding as claimed in claim 12, wherein the flexible printed circuit board further has a plurality of vias for connecting the first circuit and the second circuit.

14. The slotless winding as claimed in claim 12, wherein the flexible printed circuit board has a first surface and a second surface, the first surface comprises at least one first winding region, the second surface comprises at least one second winding region, the circuit comprises at least one first winding coil and at least one second winding coil, each first winding coil is located in each first winding region, each second winding coil is located in each second winding region, each first winding coil comprises a plurality of mutually parallel coils wound by a wire, and each second winding coil comprises a plurality of mutually parallel coils wound by a wire.

15. A method of manufacturing a slotless winding for a rotating electric machine, comprising:
(a) providing at least one flexible printed circuit board;
(b) forming at least one circuit on a surface of or inside each flexible printed circuit board; and
(c) making the flexible printed circuit board(s) form a barrel shape.

16. The method as claimed in claim 15, wherein in step (b), the circuit comprises a plurality of wires.

17. The method as claimed in claim 16, wherein the wires are mutually connected in parallel.

18. The method as claimed in claim 15, wherein in step (a), at least one winding region is pre-divided from the flexible printed circuit board; and in step (b), the circuit comprises at least one winding coil, each winding coil is located in each winding region, and each winding coil comprises a plurality mutually parallel coils wound by a wire.

19. The method as claimed in claim 15, wherein in step (b), the circuit has a plurality of wire groups serially connected by at least one wire.

20. The method as claimed in claim 19, wherein the wire groups are disposed on different layers of the flexible printed circuit board and connected by vias.

21. The method as claimed in claim 19, wherein each wire group comprises a plurality of parallel wires, and the parallel wires are mutually connected in parallel.

22. The method as claimed in claim 15, wherein in step (b), the circuit has a first circuit and a second circuit, and the first circuit and the second circuit are located on different layers of the flexible printed circuit board.

23. The method as claimed in claim 22, wherein the flexible printed circuit board further has a plurality of vias for connecting the first circuit and the second circuit.

24. The method as claimed in claim 15, wherein the flexible printed circuit board has a first surface and a second surface, the first surface comprises at least one first winding region, the second surface comprises at least one second winding region, the circuit comprises at least one first winding coil and at least one second winding coil, each first winding coil is located in each first winding region, each second winding coil is located in each second winding region, each first winding coil comprises a plurality of mutually parallel coils wound by a wire, and each second winding coil comprises a plurality of mutually parallel coils wound by a wire.
